(19) United States
(12) Patent Application Publication
(10) Pub. No.: US 2010/0190439 A1
(43) Pub. Date: Jul. 29, 2010

(54) MESSAGE TRANSMISSION PROTOCOL FOR SERVICE DELIVERY NETWORK

(75) Inventors: Henry Heping Huang, Canton, MI (US); Michael Raymond Westra, Plymouth, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/361,741

(22) Filed: Jan. 29, 2009

(51) Int. Cl. H04B 7/00; G06F 15/16

(52) U.S. Cl. 455/41.2; 709/204

(57) ABSTRACT

A reliable protocol is provided for transporting messages between a vehicle-based system and a service delivery network. The protocol is a request/response protocol and can be passed over half duplex or full duplex lines, using a data over voice communication method through a nomadic device such as a PDA or cell-phone. The protocol can also be passed over a data connection such as a dial-up or broadband connection on a nomadic device having a data plan.

### TECHNICAL FIELD

The illustrative embodiments generally relate to a protocol for communication between a vehicle-based computing system and a service delivery network (SDN).

### BACKGROUND

A variety of different protocols exist for wireless communication. For example, BlueTooth devices may be compatible with PPP, TCP/UDP/IP, and OBEX protocols, to name a few.

The PPP protocol includes, among other things, a PPP frame. This frame includes a one to two byte protocol field, an N byte information field, and a padding of zero or more bytes. These frames may then be placed in a lower-layer protocol, having its own structure. This structure may include a one byte flag indicating the start of a frame, an address field of one byte, a control field of one byte, and a two-four byte frame check sequence field. By receiving this standard format of information, systems using PPP protocol know how to interpret incoming packets.

IP protocol packets come in various forms as well. One IPv4 packet header consists of four bits for a version, four bits for a header length, one byte for a quality of service (QoS), two bytes for a packet length, two bytes for an ID tag, three bits for a fragment offset, one byte for a time to live (TTL), one byte for a protocol type, two bytes for a header checksum, and four bytes for each of a source IP address and a destination address. Again, the receiving system can parse these bytes and, by knowing what version and protocol is being used, appropriately process incoming packets.

### SUMMARY OF ILLUSTRATIVE EMBODIMENTS

In at least one illustrative embodiment, a protocol is capable of operating over both half and full duplex communications links, and provides security services including authentication, message integrity checking and privacy. For example, the protocol can operate over a half-duplex communications link providing approximately 400 bits per second.

In another illustrative embodiment, the protocol is flexible enough to allow a wide range of value-added services to be used by clients. These services can include, but are not limited to: geo-bounding, location uploading, vehicle health report, remote vehicular functions and emergency services.

According to another illustrative embodiment, the protocol may be transport/bearer agnostic. One transport mechanism for the protocol is data-over-voice (DOV) via a voice channel. The DOV link provides a reliable signaling method between the client and the SDN and provides reliable messaging.

In one illustrative embodiment, a vehicle communication system is provided. The system includes at least a computer processor in communication with persistent and non-persistent memory and a local wireless transceiver in communication with the computer processor. The local wireless transceiver may be configured to communicate wirelessly with a wireless device located at the vehicle. The persistent memory may include an application for execution by the computer processor to communicate with a remote network. In this illustrative embodiment, the communication includes at least: one or more bits defining whether a response to the message is required; one or more bits defining whether the message includes an electronic serial number (ESN); one or more bits defining a service type; one or more bits defining a payload size; and one or more bits defining a payload.

### BRIEF DESCRIPTION OF THE DRAWINGS

Other objects, aspects and characteristics of the illustrative embodiments will become apparent from the following detailed description of exemplary embodiments, when read in view of the accompanying drawings, in which:

FIG. 1 shows an exemplary illustrative vehicle-based system capable of utilizing the protocol described herein;

FIG. 2 shows an exemplary illustrative client-server interaction;

FIG. 3 shows an exemplary illustrative message format according to one illustrative embodiment;

FIG. 4 shows another exemplary illustrative message format according to one illustrative embodiment;

FIG. 5 shows still a further exemplary illustrative message format according to one illustrative embodiment;

FIG. 6 shows an exemplary illustrative flow for an exemplary system using one illustrative embodiment;

FIG. 7 shows another exemplary illustrative flow for an exemplary system using one illustrative embodiment;

FIG. 8 shows an exemplary illustrative message format used in the flow shown in FIG. 6;

FIG. 9 shows an exemplary illustrative request message format used in the flow shown in FIG. 7; and

FIG. 10 shows an exemplary illustrative response message format used in the flow shown in FIG. 7.

### DETAILED DESCRIPTION OF ILLUSTRATIVE EMBODIMENTS

The illustrative embodiments provide, among other things, communication security services including, but not limited to: authentication, message integrity checking, privacy, etc. For example, a message can be authenticated to ensure that it came from a proper source. The integrity of a message can also be checked, to ensure that data is not missing. The messages can also be encrypted to ensure against people intercepting and reading the contents of transported messages.

In at least one illustrative embodiment, the protocol is used as a SYNC Protocol (SYNCP) for SYNC for modules accessing SYNC services provided by a Service Delivery Network (SDN). In this illustrative embodiment, the data exchange between the SYNC modules and SDN via data-over-voice (DOV) utilize SYNCP.

For example, the SYNCP may be used to transport Telematics (a DOV application) requests and responses between the SYNC module and the SDN. The initial SYNCP provides a reliable signaling method between the SYNC Module and the SDN.

Clients (e.g., SYNC Modules) can utilize the protocol for a variety of uses including, but not limited to: geo-bounding, location uploading, vehicle health report, remote vehicular functions, emergency services, and a host of value-added services. The SDN provides the transport infrastructure and, for example, the Telematics services. The protocol enables the client and the SDN to provide personalized, position specific content that is both desirable and useful.

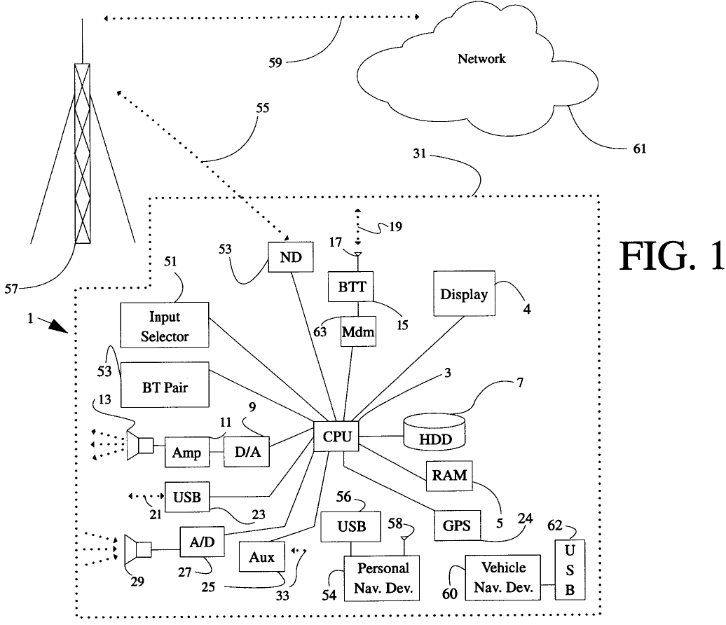

One non-limiting example of a system that is capable of utilizing the protocol is shown in FIG. 1. A vehicle enabled with a vehicle-based system such as a vehicle communication and entertainment system (VCES) may contain a visual front end interface 4 located in the vehicle. The user may also be able to interact with the interface if it is provided, for example, with a touch sensitive screen. In another illustrative embodiment, the interaction occurs through audible speech and speech synthesis.

In the illustrative embodiment 1 shown in FIG. 1 a processor 3 controls the operation of the system. Provided within the vehicle itself, the processor allows onboard processing of commands and routines. Further, the processor is connected to both temporary 5 and permanent storage 7. In this illustrative embodiment, the temporary storage is random access memory (RAM) and the permanent storage is a hard disk drive (HDD) or flash memory.

The processor is also provided with a number of different inputs for the user to interface with the processor. In this illustrative embodiment, a microphone 29, an auxiliary input 25, a USB input 23 and a BLUETOOTH input 15 are all provided. An input selector 51 is also provided, to allow a user to swap between various inputs. Input to both the microphone and the auxiliary connector is converted from analog to digital by a converter 27 before being passed to the processor.

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device or a USB device along the bi-directional data streams shown at 19 and 21 respectively.

In at least one illustrative embodiment, the system 1, uses the BLUETOOTH transceiver 15 to communicate 17 with a user's nomadic device 53 (e.g., cell phone, smart phone, PDA, etc.). The nomadic device can then be used to communicate 59 with a network 61 (such as an SDN) outside the vehicle 31 through, for example, communication 55 with a cellular tower 57.

Pairing a nomadic device 53 and the BLUETOOTH transceiver 15 can be instructed through a button 53 or similar input, telling the CPU that the onboard BLUETOOTH transceiver will be paired with a BLUETOOTH transceiver in a nomadic device.

Data may be communicated between CPU 3 and network 61 utilizing a broadband wireless data-plan associated with nomadic device 53. Alternatively, it may be desirable to include an onboard modem 63 in order to transfer data between CPU 3 and network 61 over the voice band. In at least one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example).

If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is affixed to vehicle 31.

In one embodiment, incoming data can be passed through the nomadic device via a data-over-voice or data-plan, through the onboard BLUETOOTH transceiver and into the vehicle's internal processor 3.

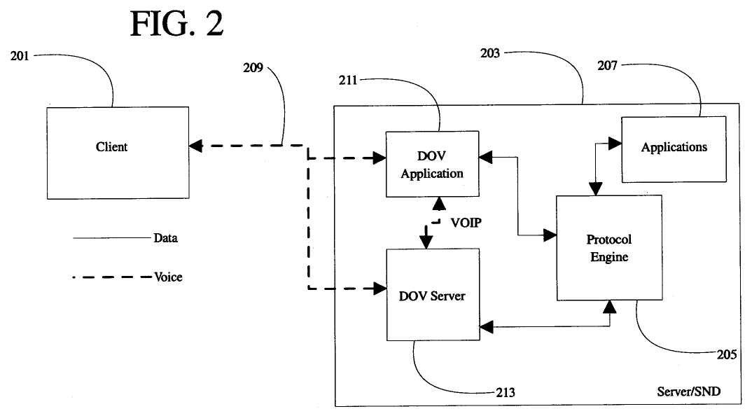

In one embodiment, the protocol may define a data services message format, message security, message integrity check, and message exchange procedures between the client and SDN. The protocol may be implemented in both the client 201 and server (e.g. SDN) 203 as shown in FIG. 2. In the SDN, a Protocol Engine 205 may provide a single access point for applications 207 to exchange data with the client 201. The protocol may be defined independent of data transport providers. The protocol message and its data payload may be hidden from the data transport provider. In at least one illustrative non-limiting example, only the client and the Protocol Engine can interpret the content of the protocol message and only the application handler (or service handler) can interpret the content of message data payload. This configuration is not required, however.

The protocol may be implemented as a request/response protocol. The request can be initiated from either the client or the SDN. In one embodiment, each request may have a response unless a waiver is indicated in the request flag. The protocol may be transport/bearer agnostic, but one transport mechanism for the protocol is data-over-voice (DOV) via a voice channel 209. This allows transmission of data using nomadic devices that do not include (or lack a subscription for) a broadband data plan. If a nomadic device can only transmit voice signals, the protocol still is capable of transmitting information over the voice signals using DOV. For events that require DOV as the primary means of communication between the client and the SDN, the client may be responsible for establishing the voice connection to the SDN. With voice channel connected, the DOV transport provider may be responsible for setting up a DOV link. After the DOV link is created, either the client or SDN can send a message to the other end. The SDN and client can continue to communicate in this manner until the DOV link or voice channel is disconnected.

The SDN may also include one or more DOV applications 211 and/or one or more DOV servers 213. The DOV applications may be able to respond directly to DOV requests, or they may require communication with a DOV server to respond. Additionally, either or both may be in communication with a protocol engine.

In at least one illustrative embodiment, the protocol is a left justified bit stream delivered from the left to right through the network. In this non-limiting embodiment, protocol messages are delivered MSB first.

In at least one illustrative embodiment, the protocol may built on top of a reliable transport layer. If the payload passed to transport is too big, the transport layer may be responsible for packet segmentation. If multiple and simultaneous data requests (on the same DOV link) are required from different applications, the transport layer may be responsible for session management for each data session, similar to a TCP/IP socket.

To reduce the overhead of a message, the request and response can be packed with following non-limiting, non-exhaustive options:

Low bandwidth and high bandwidth mode—in the low bandwidth mode, the following header space may be saved: two bytes (or octets) for a Payload Size field, eight bytes for an Initialization Vector (with security feature on), eight bytes for a Tag (with security feature on).

Secured and non-secured mode—In non-secured mode, both Initialization Vector and Tag fields may not be needed and, for example, sixteen to thirty two bytes are saved.

With or without electronic serial number (ESN)—a ESN field may be used to tag a message with an electronic serial number which may be used, among other things, to identify a sender of a message or a vehicle from which a message was sent.

In at least one illustrative embodiment, for low bandwidth transport, a minimum overhead (exclude the data payload) is five bytes and a maximum overhead is twenty nine bytes with ESN, and security options. Of course, the minimum and maximum overhead could change with variance in the protocol.

A message can be encrypted with symmetric keys shared between the client and the SDN. To enforce encryption, both Initialization Vector (IV) and Signature Tag fields may be required. If only for authentication (signing), the Signature Tag field may alone be required. An exemplary, non-limiting message can be packed in the following exemplary fashion:
1. No security, everything clear text
2. Message is signed (includes Signature Tag field)
3. Message is signed and encrypted, or encrypted (includes both IV and tag)

For a slow DOV connection, eight bytes may be sufficient for both IV and Tag. For a faster connection (e.g., a data plan connection), sixteen bytes or more may be used. Encryption may only encompass the application data payload itself. Integrity (signing) may encompass the entire message including the header and IV. Encryption and Integrity may be varied as is appropriate for a given situation.

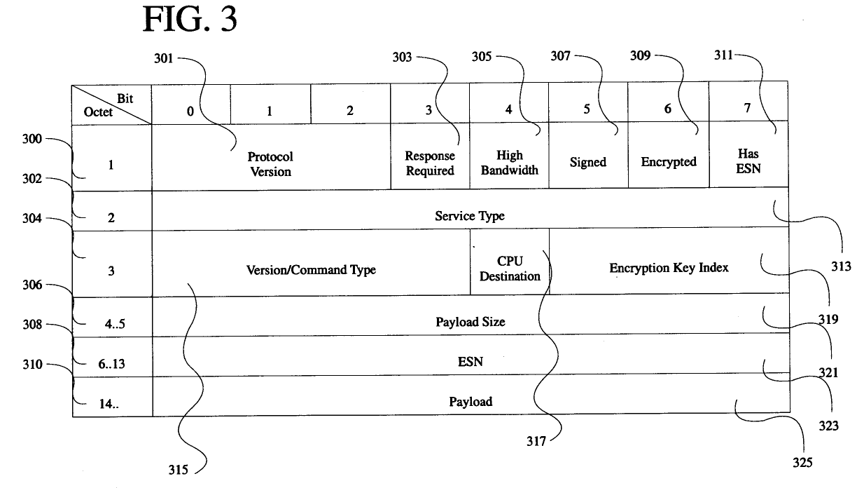

For low bandwidth transport, if encryption and signing are not required, FIG. 3 provides an exemplary, non-limiting example of request and response message format.

In this illustrative embodiment, the first octet 302 comprises the following:
1. Protocol version 301—This particular illustrative embodiment allows up to 8 different protocol versions ranging from 000 to 111.
2. Response Required 303—If set, it indicates the response to the request is required.
3. High Bandwidth 305—If set, it indicates the message is packaged with format for high bandwidth transport.
4. Signed 307—If set, it indicates the message is signed.
5. Encrypted 309—If set, the message is encrypted with key indicated by an encryption key index. Otherwise no encryption is enforced.
6. ESN 311—If set, ESN 323 is required. Otherwise ESN is omitted and, for example, eight octets 308 are saved. The ESN may be unique to each client and it is, in this illustrative embodiment, eight bytes in length.

According to this illustrative embodiment, the second octet 304 is the service type 313. Service type is used by the protocol to determine the service handler for the message. The protocol does not interpret the payload. According to this illustrative embodiment, only the service handler (the application at either client or server) interprets the payload. An application can embed multiple layers of subtypes inside the payload if necessary.

The ESN may provide a unique identification of the module sending the message. Through lookups on the back end, a system receiving the ESN could find a VIN, the status of a service subscription, who the registered consumer (at least for the vehicle) is, and numerous other types of information.

The third octet 304 comprises the following:
1. Version/Command Type 315—This field may be application specific and it may be the responsibility of each service to set its value.
2. CPU Destination 317—the client may comprise a CE-based CCPU, and FNOS-based VMCU, which may have direct CAN access and control the watchdog and power management and act as a firewall for CAN messages from the CCPU to CAN. If set, the message is bound for CCPU, otherwise it is for VMCU.
3. Encryption Key Index 319—the client may have eight 128-bit symmetric keys provisioned at end-of-line, and securely stored in a security infrastructure. The index indicates which key is used for payload encryption. It is ignored if encryption and signing are not enforced.

Service type is used by SYNC protocol to determine the service handler (e.g., application) for the message.

In at least one exemplary embodiment, the VCMU may be an ECU that is designed to automotive grades. The VCMU may also be the power master, and/or it may mediate access to the CAN network on which ECUs communicate. In these illustrative embodiments, the destination bit can effectively be set to communicate with any ECU in the vehicle in a secure manner.

In addition, in at least one illustrative embodiment, the VCMU may have a secure message service specification which includes support for: adding/removing CAN messages from a whitelist (the firewall filtering table on the VCMU); a challenge/response mechanism to prevent replay attacks; writing PID/DID data to a target ECU (PIDs are essentially exposed variables on ECUs, on which the CAN can be used to get/set configuration data—e.g. unlock doors, start/stop engine, etc.); unlocking the security of an outbound diagnostic channel (allows remote diagnostics); writing method 2/programming (allowing flashing/reprogramming ECUs remotely); starting/stopping service routines (code routines exposed by ECUs for diagnostic testing, hardware testing, etc.); and adding new targets for display handles (allowing CCPU to support additional displays).

In at least one illustrative embodiment, the service type or version/command may be laid out at a known offset so hardware on a backend can be used to inspect and process the packet. The packet can then be transformed into XML and routed appropriately.

Additionally, the two fields may be split such that the service type is assigned to a grouping of applications and then within the application are sub-commands provisioned locally for the application.

If the High Bandwidth bit is set, the message is for high bandwidth transport. Otherwise it is for low bandwidth transport. The Payload Size field 321 is four bytes for high bandwidth transport and two bytes 306 for low bandwidth transport. In this illustrative embodiment, the maximum data payload for high bandwidth transport is 4 GB and 64 KB 310 for low bandwidth transport. The value of Payload Size 321 indicates the number of bytes attached as payload 325.

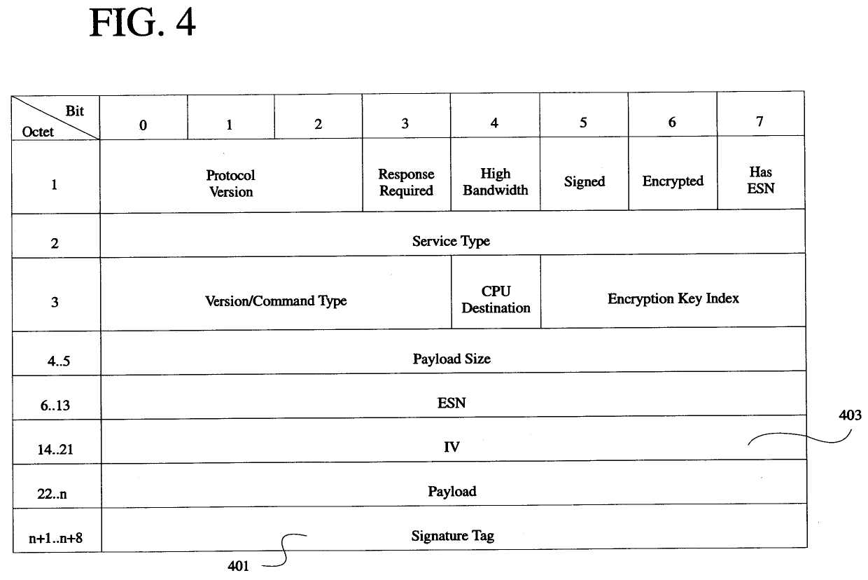

For low bandwidth transport, if encryption or signing are required, exemplary illustrative non-limiting formats for request and response messages are shown in FIG. 4. While many octets are used for the same purposes as those in FIG. 3, FIG. 4 also has a Signature Tag 401 and an Initialization Vector 403. Both Signature Tag and Initialization Vector are eight bytes long for low bandwidth transport and sixteen bytes for high bandwidth transport in this exemplary embodiment. According to this embodiment, Signature Tag and Initialization Vector are present only if encryption or signing is enabled.

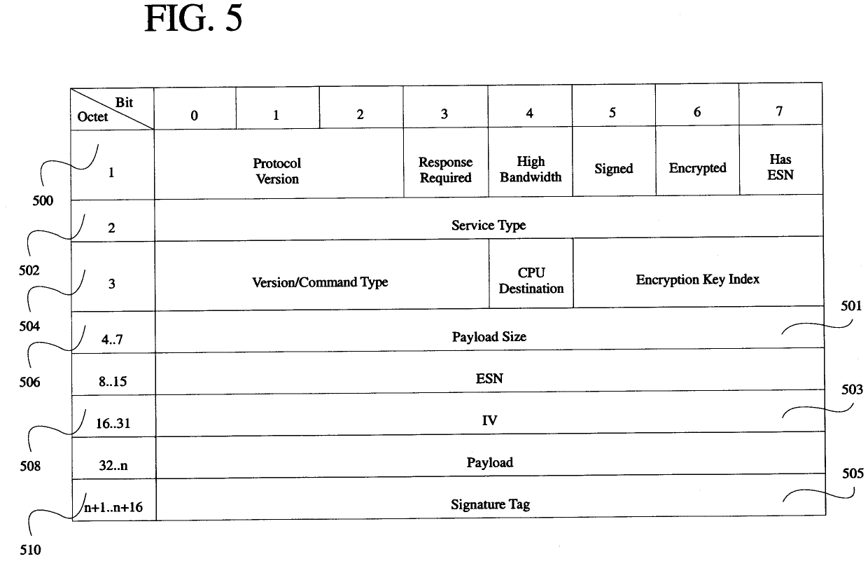

If the a flag indicates a message is for high bandwidth, and if encryption and signing are required, FIG. 5 shows an illustrative example of formats for request and response messages. The first three octets 500, 502 and 504 are used for the same information as those of FIGS. 3 and 4. When the message is for high bandwidth transport, the Payload Size field 501 takes four bytes 506, and both Initialization Vector 503 and Signature Tag 505 fields take sixteen bytes 508, 510.

In at least one illustrative embodiment, the response to the message request is application specific. Each application can define its own response using the same message format as the request. The response's payload contains the content of the response. For example, at least one illustrative system using the protocol can pack vehicle data inside the response. When received at the SDN, the response data is checked. If the data contains anything critical, the SDN can send a message request for further action.

The protocol ensures the reliable, secured message exchange between a client and server. In at least one illustrative embodiment, the data payload of each application can only be interpreted by the application itself (at client and server). The data payload of the application is attached to a protocol message with a message header. The header may include a service type, which is used at client and server to identify the service handler, e.g., a specific application.

When a data payload is to be delivered to the peer at the other end, the protocol attaches its header and pushes it to the lower transport layer for delivery. In at least one embodiment, the protocol header and application payload is invisible to lower transport layer. If lower transport layer needs to know the payload and header size, the protocol can pass the information to a transport API.

In summary, the protocol works with transport layer to provide a secure and reliable transport for peer-to-peer message exchange.

What follows are two exemplary, illustrative, non-limiting implementations showing illustrative embodiments of the above-described protocol in sample environments. The examples are not meant to be limiting in any fashion, but rather provide samples of what can be done with the protocol described herein.

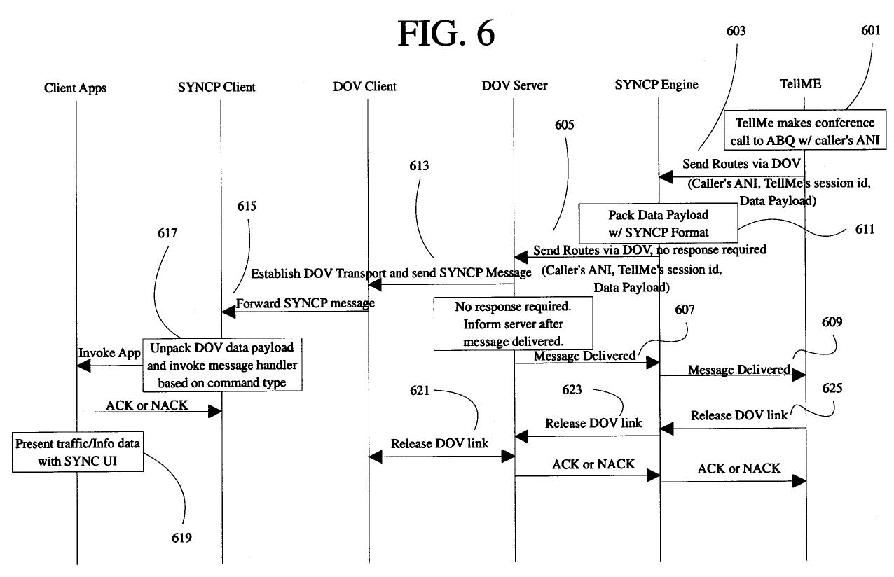

In the first sample environment, the system implementing the protocol is the FORD SYNC system. The protocol is referred to as SYNCP, TELLME (TME) is a DOV application, and AIRBIQUITY (ABQ) is a DOV server. FIG. 6 shows an exemplary data process and flow for the session When TME needs to pass traffic data to SYNC, it makes a conference call to ABQ with the original caller's automatic number identification (ANI) 601. Then TME invokes a web service (WS) call to the Ford server (Ford SDN, where SYNCP resides) with parameters including caller's ANI, TME's session ID, and data payload (traffic data) 603. In this example, Session ID consists of vendor ID and vendor's application session ID. ABQ uses TME's Session ID for billing. TME's Session ID is passed among TME, the Ford SDN 603, and ABQ 605. SYNCP does not maintain any session data. ABQ and TME are responsible for maintaining the session data. When a response is sent back from ABQ (e.g., message delivered) 607, the response can be routed back to TME based on its vendor ID (derived from Session ID) 609.

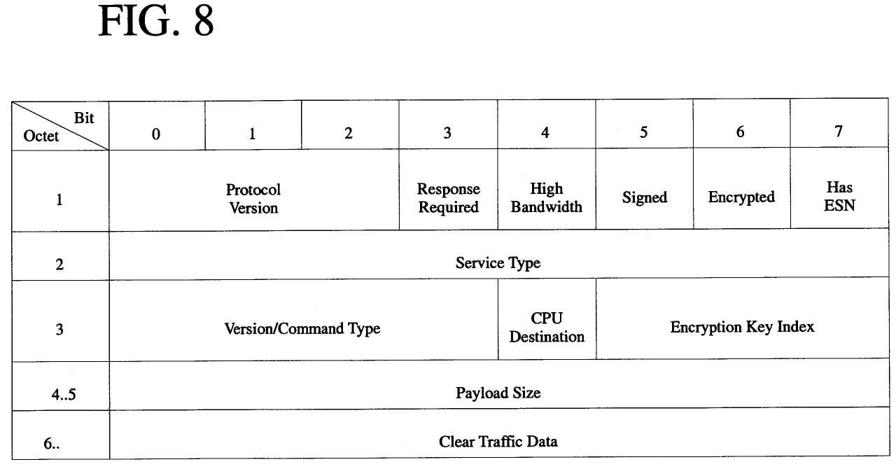

Upon receiving the “Send Routes” WS call from TME, the SYNCP API is invoked to pack a SYNCP message 611. The message can use the following options: no encryption, no signing, low bandwidth, no response required, no ESN. The message has a five byte header and may be formatted as shown in FIG. 8.

After traffic data is packed with SYNCP format 611, the Ford SDN makes a WS call to ABQ and pass the SYNCP data packet to ABQ to be delivered via DOV link 613. If any error occurs, ABQ invokes a Ford WS call and the Ford SDN passes the error message back to TME. If no error, traffic data is sent to the SYNC client. SYNC client passes the message and invokes the client traffic application indicated by the message type and passes the traffic data to the application 617. The application can then use the traffic data as needed 619. Since no response is required, TME can send more traffic data or instruct ABQ to terminate DOV link 625, 623, 621.

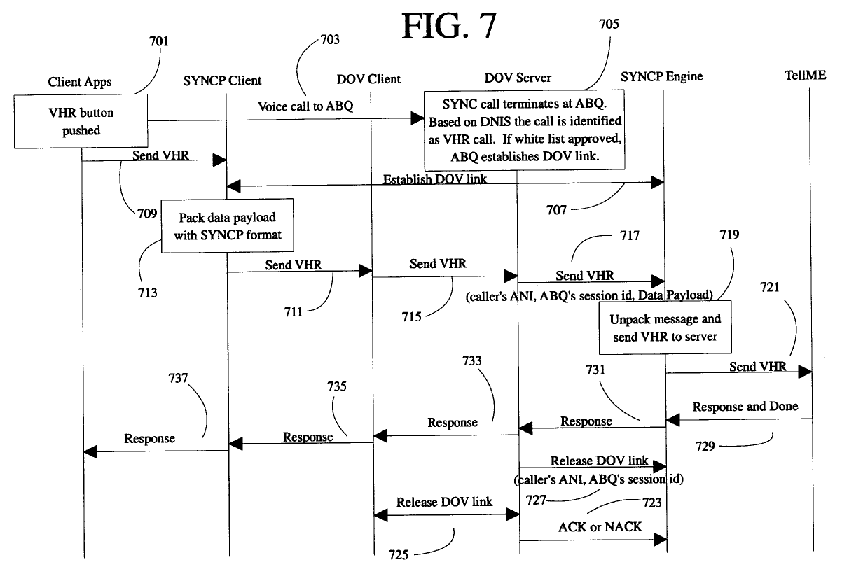

In the second sample environment, the system implementing the protocol is also the Ford SYNC system. The protocol is referred to as SYNCP, TME is the server-side DOV application, and ABQ is a DOV server. FIG. 7 shows an exemplary data process and flow for the session. Although examples of use of the protocol have been shown including the SYNC system, the protocol described herein is useful for a variety of applications and is not meant to be limited to the SYNC system.

When a vehicle health report (VHR) is requested using SYNC 701, SYNC makes a voice call to ABQ 703. Based on the call's DNIS, the call is identified as VHR call 705. If the call is white-list approved, ABQ establishes the DOV link on top of the voice connection 707. The white-list validation can be done at Ford or at ABQ. If validation is done at Ford, ABQ needs to send WS message to FORD with the caller's ANI.

Immediately after the voice call, the VHR client requests a DOV session with SYNCP to forward the VHR 709. SYNCP passes the request to the DOV client. After the DOV link is established, SYNCP is notified. SYNCP packs the VHR payload with SYNCP format 713 and forwards the SYNCP message to the DOV client 711 to be delivered to the Ford server (with SYNCP engine) 717 over the DOV server (ABQ) 715. After DOV server receives the message (which could be segmented into multiple DOV messages and assembled back to one SYNCP message), it makes a WS call to the Ford server 717. The Ford server unpacks the message with SYNCP APIs (e.g., inside a jar file) 719 and forwards the VHR to a VHR handler at a backend server 721. The Ford server makes a WS call to ABQ server to send back ACK or NACK 723 and asks ABQ to release DOV link 725, 727.

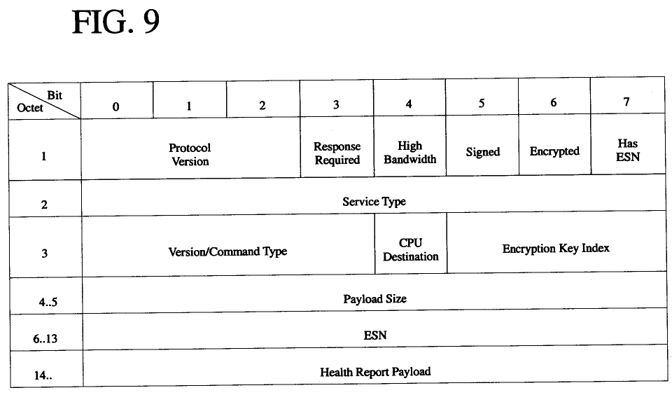

The VHR request message can use the following options: no encryption, no signing, low bandwidth, response required, ESN present. The message has a thirteen byte header and may be formatted as shown in FIG. 9.

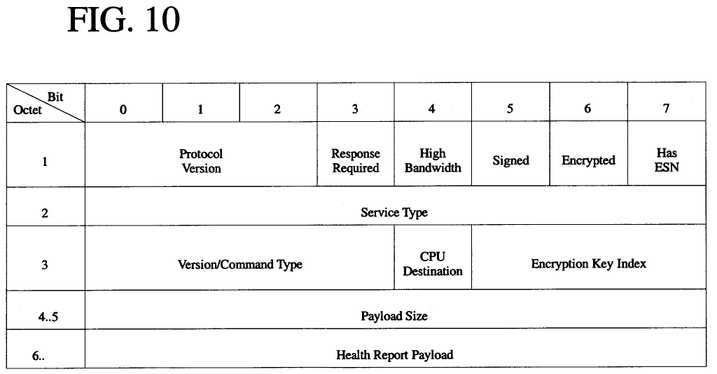

The VHR response message can use the following options: no encryption, no signing, low bandwidth, and no ESN. The response is sent all the way from TME to the client VHR app 729, 731, 733, 735, 737. The message has a five byte header and may be formatted as shown in FIG. 10.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed:

1. A computer readable storage medium storing a message, wherein the message is initiated by a vehicle application and sent to a remote service location to be processed, the processing resulting in delivery to the vehicle of information contained in a payload, the message comprising:
one or more bits defining whether a response to the message is required;
one or more bits defining whether the message includes an electronic serial number (ESN);
one or more bits defining a service type;
one or more bits defining a payload size; and
one or more bits defining a payload.

2. The computer readable storage medium of claim 1, wherein the computer readable storage medium includes persistent or non-persistent memory.

3. The computer readable storage medium of claim 1, wherein if the one or more bits defining whether the message has an ESN define that the request has an ESN, the message further includes one or more bits defining an ESN.

4. The computer readable storage medium of claim 1, further including one or more bits defining an initialization vector.

5. The computer readable storage medium of claim 1, further including one or more bits defining a signature tag.

6. The computer readable storage medium of claim 1, further including one or more bits defining a protocol version.

7. The computer readable storage medium of claim 1, wherein whether a response is required is defined by one bit.

8. The computer readable storage medium of claim 1, further including one or more bits indicating whether high bandwidth is to be used for transmission.

9. The computer readable storage medium of claim 1, further including one or more bits defining whether the message is signed, wherein whether a message is signed is defined by one bit.

10. The computer readable storage medium of claim 1, further including one or more bits defining whether the message is encrypted, wherein whether a message is encrypted is defined by one bit.

11. The computer readable storage medium of claim 1, wherein whether a message has an ESN is defined by one bit.

12. The computer readable storage medium of claim 1, wherein the service type is defined by eight bits.

13. The computer readable storage medium of claim 1, further including one or more bits defining version or command type, wherein the version or command type is defined by four bits.

14. The computer readable storage medium of claim 1, further including one or more bits defining a cpu destination, wherein the CPU destination type is defined by one bit.

15. The computer readable storage medium of claim 1, further including one or more bits defining an encryption key index, wherein the encryption key index is defined by three bits.

16. The computer readable storage medium of claim 1, wherein the payload size is defined by eight bits.

17. The computer readable storage medium of claim 1, wherein the service type is defined by eight bits.

18. The computer readable storage medium of claim 3, wherein the ESN is defined by sixteen or thirty-two bits.

19. The computer readable storage medium of claim 4, wherein the initialization vector is defined by sixty four or one hundred twenty eight bits.

20. The computer readable storage medium of claim 5, wherein the signature tag is defined by sixty four or one hundred twenty eight bits.

21. A vehicle communication system comprising:
a computer processor in communication with persistent and non-persistent memory;
a local wireless transceiver in communication with the computer processor, wherein the local wireless transceiver is configured to communicate wirelessly with a wireless device located at the vehicle, and wherein the persistent memory includes an application for execution by the computer processor to communicate with a remote network, the communication including:
one or more bits defining whether a response to the message is required;
one or more bits defining whether the message includes an electronic serial number (ESN);
one or more bits defining a service type;
one or more bits defining a payload size; and
one or more bits defining a payload.
